(19) United States
(12) Patent Application Publication
(10) Pub. No.: US 2014/0359173 A1
(43) Pub. Date: Dec. 4, 2014

(54) PORT INDICATING CIRCUIT FOR HARD DISK BACKPLANE AND SERVER SYSTEM

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: KANG WU, Shenzhen (CN); BO TIAN, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/288,593

(22) Filed: May 28, 2014

(30) Foreign Application Priority Data
May 28, 2013 (CN) 2013102032892

(51) Int. Cl. G06F 3/06

(52) U.S. Cl. CPC G06F 3/0653; G06F 3/0604; G06F 3/0676; G06F 2003/0692
USPC 710/19

(57) ABSTRACT

A port indicating circuit for a hard disk backplane of a server system includes a port circuit and an indicating circuit. The port circuit includes a control microchip and at least one selecting microchip. The hard disk backplane includes a number of ports. The server system includes a number of servers connected to some of the ports. The selecting microchip is connected to the control microchip and the remaining ports. If the control microchip detects that one or more standby servers form part of the server system, the control microchip selects the one or more standby server to connect to the remaining ports. If the control microchip does not detect that the one or more standby servers form part of the server system, the control microchip selects the servers to connect to the remaining ports. The indicating circuit indicates operating status of hard disks on the hard disk backplane.

### CROSS-REFERENCE TO RELATED APPLICATIONS

This application is related to a commonly-assigned application having application Ser. No. 13/523877, entitled “PORT CIRCUIT FOR HARD DISK BACKPLANE AND SERVER SYSTEM”, and filed on Jun. 14, 2012. Disclosure of the above-identified application is incorporated herein by reference.

### FIELD

The present disclosure relates to hardware circuits for computers, and particularly to a port indicating circuit for a hard disk backplane and a server system using the port circuit.

### BACKGROUND

A 2U server system is a server system with at least 2 servers. A 4-in-1 2U server system includes four servers sharing a hard disk backplane. Commonly, each server can provide six groups of serial advanced technology attachment (SATA) signals to the hard disk backplane to support hard disks installed on the hard disk backplane. Each hard disk backplane usually includes twelve ports configured for inserting twelve hard disks. Therefore, to control the twelve hard disks, each server outputs three groups of SATA signals to control three hard disks of the total twelve hard disks.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a circuit diagram of an embodiment of a port circuit of a port indicating circuit for a hard disk backplane of a server system of the present disclosure.

FIG. 2 is a circuit diagram of an indicating circuit of the port indicating circuit of the embodiment in FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The reference “a plurality of” means “at least two.”

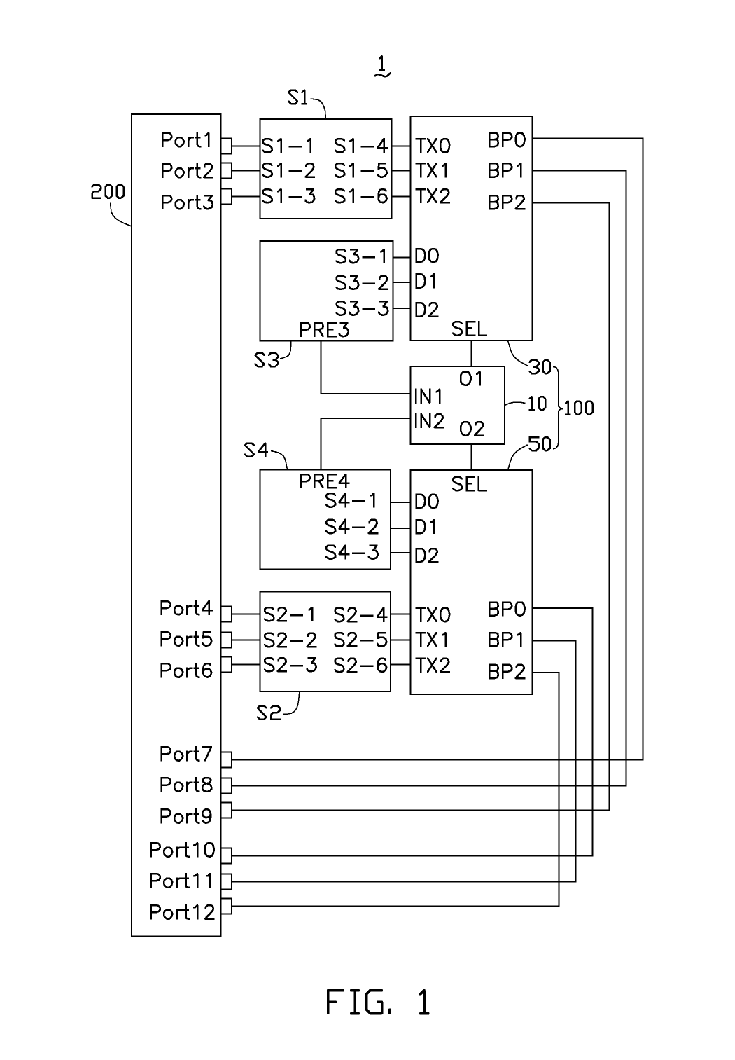

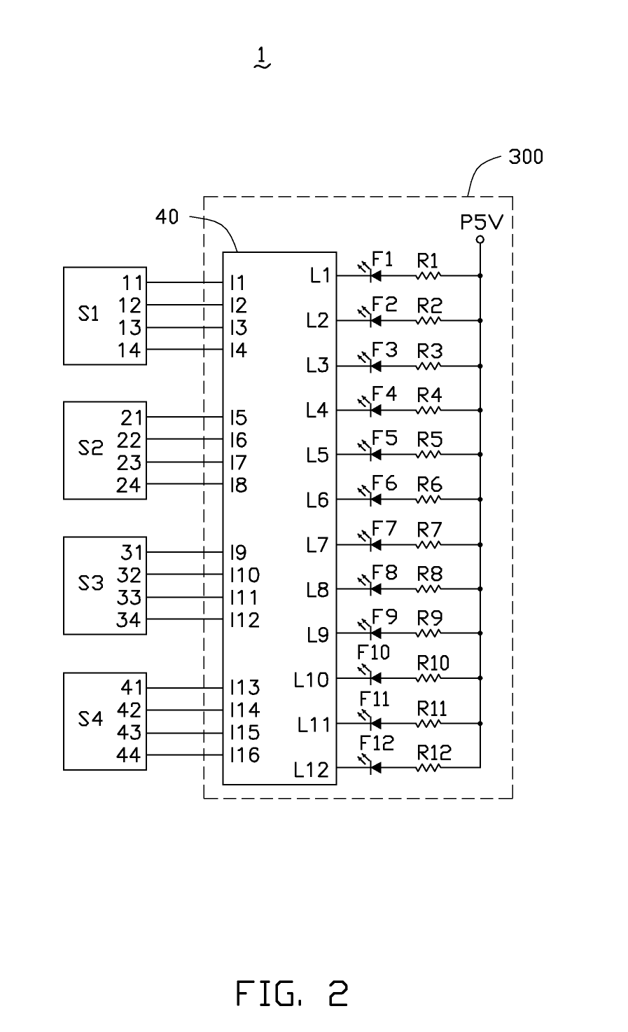

FIG. 1 and FIG. 2 show an embodiment of a port indicating circuit 1 for a hard disk backplane of a server system. The port indicating circuit 1 can comprise a port circuit 100 shown in FIG. 1 and an indicating circuit 300 shown in FIG. 2.

The server system can be a 2U server system, in this embodiment, the port circuit 100 is applied to the 2U server system as an example. The 2U server system can include two servers S1, S2 and two standby servers S3, S4. The two servers S1, S2 form part of the 2U server system and the two standby servers S3, S4 can selectively form part of the 2U server system. The term “form part” means that the servers are electronically connected in the appropriate connection for a 2U server configuration.

The port circuit 100 can be installed on the hard disk backplane 200. The hard disk backplane 200 can include twelve ports Port1-Port12 configured for inserting hard disks. The port circuit 100 can include a control microchip 10 and two selecting microchips 30, 50.

The server S1 can include a group of SATA signal output terminals S1-1, S1-2, S1-3, S1-4, S1-5, and S1-6. The SATA signal output terminals S1-1, S1-2, and S1-3 are respectively connected to the ports Port1-Port3 of the hard disk backplane 200 and respectively output SATA signals S11, S12 and S13 to the ports Port1-Port3. The SATA signal output terminals S1-4, S1-5, and S1-6 are electrically connected to the selecting microchip 30 and respectively output SATA signal S14, S15, and S16 to the selecting microchip 30.

The structure of the server S2 is substantially similar to the server S1 and includes a group of SATA signal output terminals S2-1, S2-2, S2-3, S2-4, S2-5 and S2-6. The SATA signal output terminals S2-1, S2-2, and S2-3 are respectively connected to the ports Port4-Port6 of the hard disk backplane 200 and respectively output SATA signals S21, S22 and S23 to the ports Port4-Port6 of the hard disk backplane 200. The SATA signal output terminals S2-4, S2-5 and S2-6 are electrically connected to the selecting microchip 50 and respectively output SATA signal S24, S25, and S26 to the selecting microchip 50.

The standby server S3 includes a group of SATA signal output terminals S3-1, S3-2, S3-3 and a triggering terminal PRE3. When the standby server S3 forms part of the 2U server system, the SATA signal output terminals S3-1, S3-2, and S3-3 are electrically connected to the selecting microchip 30 and respectively output SATA signals S31, S32 and S33 to the selecting microchip 30, and the triggering terminal PRE3 is electrically connected to the control microchip 10 through a hard disk bridging plate (not shown). In addition, a triggering signal is sent which denotes the standby server S3 having already formed part of the 2U server system to the control microchip 10.

The structure of the standby server S4 is substantially similar to the standby server S3 and includes a group of SATA signal output terminals S4-1, S4-2, S4-3 and a triggering terminal PRE4. When the standby server S4 forms part of the 2U server system, The SATA signal output terminals S4-1, S4-2, and S4-3 are electrically connected to the selecting microchip 50 and respectively output SATA signals S51, S52, and S53 to the selecting microchip 50, and the triggering terminal PRE4 is electrically connected to the control microchip 10 through a hard disk bridging plate (not shown) and sends the triggering signal which denotes the standby server S4 having already formed part of the 2U sever system to the control microchip 10.

The control microchip 10 includes two detecting terminals IN1, IN2 and two output terminals O1, O2. The two detecting terminals IN1, IN2 are respectively connected to the triggering terminal PRE3, PRE4 to receive the triggering signals. The two output terminals O1, O2 are respectively connected to the selecting microchips 30, 50.

When the detecting terminal IN1 receives the triggering signal from the standby server S3, which means the standby server S3 has already formed part of the 2U server system, the output terminal O1 outputs a first control signal, which may be a high level signal (logic 1) to the selecting microchip 30. Otherwise, the detecting terminal IN1 does not receive the triggering signal. That is the standby server S3 is not installed to the 2U server system, the output terminal O1 outputs a second control signal, which may be a low level signal (logic 0) to the selecting microchip 30.

Similarly, when the detecting terminal IN2 receives the triggering signal from the standby server S4, which means the standby server S4 has already formed part of the 2U server system, the output terminal O2 outputs the first control signal, which may be a logic 1 signal to the selecting microchip 30. Otherwise, the detecting terminal IN2 does not receive the triggering signal, which means the standby server S4 does not form part of the 2U server system, the output terminal O2 outputs a second control signal, which may be a logic 0 signal to the selecting microchip 30.

The selecting microchip 30 includes three data receiving terminals TX0, TX1, and TX2, three data input terminals D0, D1, and D2, three data output terminals BP0, BP1, and BP2, and a selecting terminal SEL.

The data receiving terminal TX0, TX1, and TX2 are respectively connected to the SATA signal output terminals S1-4, S1-5, and S1-6 and receive the SATA signals S14, S15, and S16. The three data input terminals D0, D1, and D2 are connected to the SATA signal output terminals S3-1, S3-2, and S3-3 and receive the SATA signals S31, S32, and S33. The data output terminals BP0, BP1, and BP2 are respectively connected to the ports Port7-Port9. The selecting terminal SEL is electrically connected to the output terminal O1.

When the selecting terminal SEL receives the first control signal, the data input terminals D0, D1, and D2 are selected and switched to be connected to the data output terminals BP0, BP1, and BP2. The SATA signals S31, S32, and S33 from the standby severs S3 can be transmitted to the ports Port7-Port9. When the selecting terminal SEL receives the second control signal, the data receiving terminals TX0, TX1, TX3 are selected and switched to connect to the data output terminals BP0, BP1, and BP3, and the SATA signals S14, S15, and S16 from the severs S1 are transmitted to the ports Port7-Port9.

The structure of the selecting microchip 50 is substantially similar to the selecting microchip 30 and includes three data receiving terminals TX0, TX1, and TX3, three data input terminals D0, D1, and D2, three data output terminals BP0, BP1 and BP2 and a selecting terminal SEL. The differences are the data receiving terminals TX0, TX1, and TX3 of the selecting microchip 50 are connected to the SATA signal output terminals S2-4, S2-5, and S2-6. The three data input terminals D0, D1, and D2 are connected to the SATA signal output terminals S4-1, S4-2, and S4-3. The data output terminals BP0, BP1, and BP2 are respectively connected to the ports Port10-Port12, and the selecting terminal SEL is electrically connected to the output terminal O1.

The indicating circuit 300 can comprise an indicating chip 40, twelve light-emitting diodes (LEDs) D1-D12, and twelve resistors R1-R12. The indicating chip 40 is connected to the servers S1, S2 and the standby severs S3, S4. Input pins I1, I2, I3, and I4 of the indicating chip 40 are connected to output pins 11, 12, 13, and 14 of the server S1 respectively. Input pins I5, I6, I7, and I8 of the indicating chip 40 are connected to output pins 21, 22, 23, and 24 of the server S2 respectively. Input pins I9, I10, I11, and I12 of the indicating chip 40 are connected to output pins 31, 32, 33, and 34 of the standby server S3 respectively. Input pins I13, I14, I15, and I16 of the indicating chip 40 are connected to output pins 41, 42, 43, and 44 of the standby server S4 respectively. Output pins L1-L12 of the indicating chip 40 are connected to cathodes of the LED D1-D12 respectively. Anodes of the LED D1-D12 are coupled to a power terminal P5V through resistors R1-R12 respectively.

In use, the two servers S1, S2 form part of the 2U server system. The ports Port1-Port3 receive the SATA signals S11, S12, S13 from the server S1, and the ports Port4-Port6 receive the SATA signals S21, S22, S23 from the server S2. The server S1 outputs a logic 0 signal, to the input pin I1 of the indicating chip 40. The server S2 outputs a logic 0 signal to the input pin I5 of the indicating chip 40. The indicating chip 40 determines that the server S1 and the server S2 form part of the 2U server system. The indicating chip 40 receives signals of operating information of the inserting hard disks of the servers S1 and S2 from the output pins 12, 13, and 14 of the server S1 and the output pins 22, 23, and 24 of the server S2.

When the standby server S3 forms part of the 2U server system, the triggering terminal PRE3 outputs the triggering signal to the detecting terminal IN1 and the output terminal O1 outputs the first control signal to the selecting terminal SEL. The data input terminals D0, D1, and D2 are switched to connect to the data output terminals BP0, BP1, and BP2 and the SATA signals S31, S32, and S33 from the standby severs S3 can be transmitted to the ports Port7-Port9. The standby server S3 outputs a logic 0 signal to an input pin 19 of the indicating chip 40. The indicating chip 40 receives signals of operating information of the inserting hard disks of the standby server S3 from the output pins 32, 33, and 34 of the standby server S3.

When the selecting terminal SEL receives the second control signal, the data receiving terminals TX0, TX1, TX3 are switched to connect to the data output terminals BP0, BP1, and BP3, and the SATA signals S14, S15, and S16 from the severs S1 are transmitted to the ports Port7-Port9. Therefore, whether the standby server S3 forms part of the 2U server system or not, the ports Port7- Port9 can be used.

The operation principle of the selecting microchip 50 is substantially similar to the selecting microchip 30, thus detail description of the selecting microchip 50 is omitted. Similarly, no matter if the standby server S4 forms part of the 2U server system or not, the ports Port10-Port12 can be used.

The LEDs D1-D12 are used to indicate operating status of the inserting hard disks connected to the port1-port12 respectively. When the indicating chip determines an inserting hard disk is operating abnormally, the indicating outputs a logic 0 signal through a pin corresponding to the inserting hard disk. An LED is lit correspondingly to indicate the inserting hard disk is operating abnormally.

While the disclosure has been described by way of example and in terms of an embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A port indicating circuit for a hard disk backplane of a server system, the hard disk backplane comprising a plurality of ports, the server system comprising a plurality of servers connected to a first group of the ports, the port indicating circuit comprising a port circuit and an indicating circuit, wherein the port circuit comprises:
a control microchip configured for detecting whether one or more standby servers electronically form part of the server system, the control microchip comprising at least one detecting terminal electrically connected to the one or more standby servers when the one or more standby servers form part of the server system; and
at least one selecting microchip connected to the control microchip and a second group of the ports, wherein when the control microchip detects one or more standby servers that forms part of the server system, the control microchip selects the one or more standby servers to connect to the second group of the ports via the least one selecting microchip;
wherein when the control microchip does not detect the one or more standby servers to form part of the server system, the control microchip selects the plurality of servers to connect to the second group of the ports via the least one selecting microchip; and
wherein the indicating circuit are configured to indicate operation status of hard disks on the hard disk backplane according to signals output from the plurality of servers.

2. The port indicating circuit of claim 1, wherein the at least one selecting microchip comprises a plurality of data receiving terminals connected to one of the plurality of servers, a plurality of data input terminals connected to the one or more standby servers, a plurality of data output terminals corresponding to the data receiving terminals and the data input terminals, and a selecting terminal connected to the control microchip, the plurality of data output terminals are connected to the second group of the ports, and the control microchip controls the selecting terminal to select the data receiving terminals or the data input terminals to connect to the data output terminals.

3. The port indicating circuit of claim 2, wherein the control microchip further comprises at least one output terminal connected to the selecting terminal of the at least one selecting microchip, when the one or more standby servers form part of the server system, the at least one detecting terminal receives a triggering signal from the one or more standby servers, and the at least one output terminal outputs a first control signal to the selecting terminal of the at least one selecting microchip.

4. The port indicating circuit of claim 3, wherein when the one or more standby servers do not form part of the server system, the at least one detecting terminal does not receive the triggering signal, and the at least one output terminal outputs a second control signal to the selecting terminal of the at least one selecting microchip.

5. The port indicating circuit of claim 1, wherein the indicating circuit comprises an indicating chip, a first light-emitting diode (LED), a second LED, a third LED, a fourth LED, a fifth LED, a sixth LED, a seventh LED, an eighth LED, a ninth LED, a tenth LED, an eleventh LED, a twelfth LED, a first resistor, a second resistor, a third resistor, a fourth resistor, a fifth resistor, a sixth resistor, a seventh resistor, an eighth resistor, a ninth resistor, a tenth resistor, an eleventh resistor, a twelfth resistor, the indicating circuit is connected to a first server, a second server, a first standby server, and a second standby server, the indicating chip determines whether the first server, the second server, the first standby server, and the second standby server electronically form part of the server system, the indicating chip receives signals of operating status of the hard disks from the servers electronically forming part of the server system, and the indicating chip controls the first through twelfth to indicate the operating status of the hard disks.
